(19) United States
(12) Patent Application Publication
(10) Pub. No.: US 2013/0335220 A1
(43) Pub. Date: Dec. 19, 2013

(54) Alarm Detector and Methods of Making and Using the Same

(71) Applicant: Stephen T. Scherrer, Crystal Lake, IL (US)

(72) Inventor: Stephen T. Scherrer, Crystal Lake, IL (US)

(21) Appl. No.: 13/525,080

(22) Filed: Jun. 15, 2012

(51) Int. Cl. G08B 21/00

(52) U.S. Cl. 340/540

(57) ABSTRACT

The present invention relates to an alarm detector. Specifically, the present invention relates to an apparatus for detecting an audible alarm and signaling a user regarding the detection of the audible alarm. The present invention further relates to methods of making and using the same.

### TECHNICAL FIELD

The present invention relates to an alarm detector. Specifically, the present invention relates to an apparatus for detecting an audible alarm and signaling a user regarding the detection of the audible alarm. The present invention further relates to methods of making and using the same.

### BACKGROUND

It is, of course, generally known to utilize alarms to alert people to impending dangerous conditions or circumstances. For example, it many towns, especially in the Midwest, or “Tornado Alley” in the United States, civic alarms are utilized to alert people to a tornado within the vicinity. The alarm is typically loud enough and of a variable frequency to be noticeable by individuals so that the individuals may take appropriate action. For example, upon hearing a tornado alarm, an individual may take action to protect him or herself, such as taking cover within a basement.

Of course, alarms, or sirens, may be used :for any other purpose. For example, many areas have civic defense alarms, tsunami alarms, tire alarms, or other similar alarms or sirens for alerting individuals about a particular dangerous condition, alerting the individuals to take. appropriate action.

However, alarms that may be utilized to alert individuals about impending dangerous conditions provide little to no protection if the alarm remains undetectable or unheard. In certain circumstances, individuals may be participating in an activity whereby hearing the alarm is unlikely or even impossible. Specifically, there may be much ambient noise that may make it difficult to hear a civic alarm or siren. For example, if individuals are having a party with loud music it may be difficult to hear a civic alarm or siren. In some circumstances, an alarm or siren may be located a certain distance from the home or location of an individual, and even without other ambient noise, the individual may have difficulty hearing the alarm or siren. Oftentimes, if civic alarms or sirens blare during the night, individuals may have difficulty being roused from sleep to take appropriate action. Moreover, oftentimes, especially during a storm, individuals may take cover within buildings, making it more difficult to hear the alarms or sirens because of the building structure, including the walls, floors, ceilings, roofs, etc.

As noted above, other ambient noise may make it difficult to detect a civic alarm Or siren. For example, during a storm, there may be other noise associated with the storm, such as loud rain and/or hail that may lash the building an individual may be in. In addition, high winds may make it difficult for an individual to hear a civic alarm or siren. Thunder may also create difficulty for an individual to hear a civic alarm or siren.

Of course, certain individuals may have physical limitations that make detecting an audible alarm difficult or impossible. For example, deaf individuals have no ability to aurally detect a civic alarm or siren, and in many cases must rely on others to alert them if an alarm or siren sounds.

In some circumstances, a civic alarm or siren may sound for a particular area, but an individual may be away from the particular area and may wish to know about a dangerous condition. For example, an individual may be driving to his or her house and may be unaware that a tornado alarm has sounded near his or her home. It may be better for the individual to postpone his or her travel to his or her home during this dangerous situation. On the other hand, an individual may wish to arrive home as soon as possible if a civic alarm sounds if he or she is away from his or her home to take care of or otherwise protect individuals, pets, or property.

Thus, in many circumstances, it may be difficult for an individual to hear a civic alarm or siren alerting him or her to take appropriate action. Therefore, a need exists for an apparatus to detect an alarm or siren. Moreover, a need exists for an apparatus that may detect an alarm or siren, and communicate information to the individual about the detection of the alarm or siren.

Moreover, a need exists for an apparatus to detect an alarm or siren having the ability to parse the sound of the alarm or siren from other noise. Specifically, a need exists for an apparatus to detect an alarm or siren that may be utilized to alert an individual that may have difficulty detecting the alarm or siren because of other noise. Moreover, a need exists for an apparatus to detect an alarm or siren and communicate to an individual within a building or other structure where detecting the alarm or siren may be difficult or impossible for the individual. A need further exists for an apparatus to detect an alarm or siren and communicate to an individual that may have physical difficulty aurally detecting the alarm or siren, such as a deaf individual.

In addition, a need exists for an apparatus to detect an alarm or siren that may communicate information concerning the detection to an individual that may be remotely displaced from the alarm or siren, or the apparatus. Specifically, a need exists for an apparatus to detect an alarm or siren whereupon detection of the alarm or siren, the apparatus sends a wireless signal to an individual thereby alerting the individual to the dangerous condition.

### SUMMARY OF THE INVENTION

The present invention relates to an alarm detector. Specifically, the present invention relates to an apparatus for detecting an audible alarm and signaling a user regarding the detection of the audible alarm. The present invention further relates to methods of making and using the same.

To this end, in an embodiment of the present invention, an audible detection apparatus is provided. The audible detection apparatus comprises a microphone for detecting an audible signal from a siren and an alarm, wherein the alarm may be triggered if the audio detection apparatus detects the audible signal from the siren.

In another embodiment of the present invention, a method of triggering an alarm is provided. The method comprises the steps of providing an audible signal generated front a siren, an audio detection apparatus, and an alarm; detecting the audible signal generated from the siren with the audio detection apparatus; and triggering the alarm upon detection of the audible signal generated from the siren.

In a further embodiment of the present invention, a method of triggering an alarm is provided. The method comprises the steps of providing a siren, an audio detection apparatus, and an alarm; detecting a reference audible signal from the siren; storing the reference audible signal; detecting an audible signal generated by the siren during an actual emergency; comparing the audible signal to the reference audible signal; and triggering the alarm when the audible signal matches the reference audible signal.

Thus, it is an objective of the present invention to provide an apparatus that detects an alarm or siren.

Moreover, it is an objective of the present invention to provide an apparatus that detects an alarm or siren, and communicates information to an individual about the detection of the alarm or siren.

Moreover, it is an objective of the present invention to provide an apparatus to detect an alarm or siren having the ability to parse and or otherwise isolate the sound of the alarm or siren from other noise.

Specifically, it is an objective of the present invention to provide an apparatus to detect an alarm or siren that may be utilized to alert an individual that may have difficulty detecting the alarm or siren because of other noise or when asleep.

Moreover, it is an objective of the present invention to provide an apparatus to detect an alarm or siren and communicate to an individual within a building or other structure where detecting the alarm or siren may be difficult or impossible for the individual.

It is a further objective of the present invention to provide an apparatus to detect an alarm or siren and communicate to an individual that may have physical difficulty aurally detecting the alarm or siren, such as a deaf individual.

In addition, it is an objective of the present invention to provide an apparatus to detect an alarm or siren that may communicate information concerning the detection to an individual that may be remotely displaced from the alarm or siren, or the apparatus.

Specifically, it is an objective of the present invention to provide an apparatus to detect an alarm or siren whereupon detection of the alarm or siren, the apparatus sends a wireless signal to an individual thereby alerting the individual to the dangerous condition.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a system of an audio detection apparatus for detecting an audible signal from a siren in an embodiment of the present invention.

FIG. 2 illustrates a further system of the audio detection apparatus for detecting the audible signal from a siren in an embodiment of the present invention.

FIG. 3 illustrates a method of detecting a reference audible signal and comparing the reference audible signal to a detected audible signal indicating an actual emergency to trigger an alarm to alert an individual as to the action emergency.

### DETAILED DESCRIPTION OF THE PRESENTLY PREFERRED EMBODIMENTS

The present invention relates to an alarm detector. Specifically, the present invention relates to an apparatus for detecting an audible alarm and signaling a user regarding the detection of the audible alarm. The present invention further relates to methods of making and using the same.

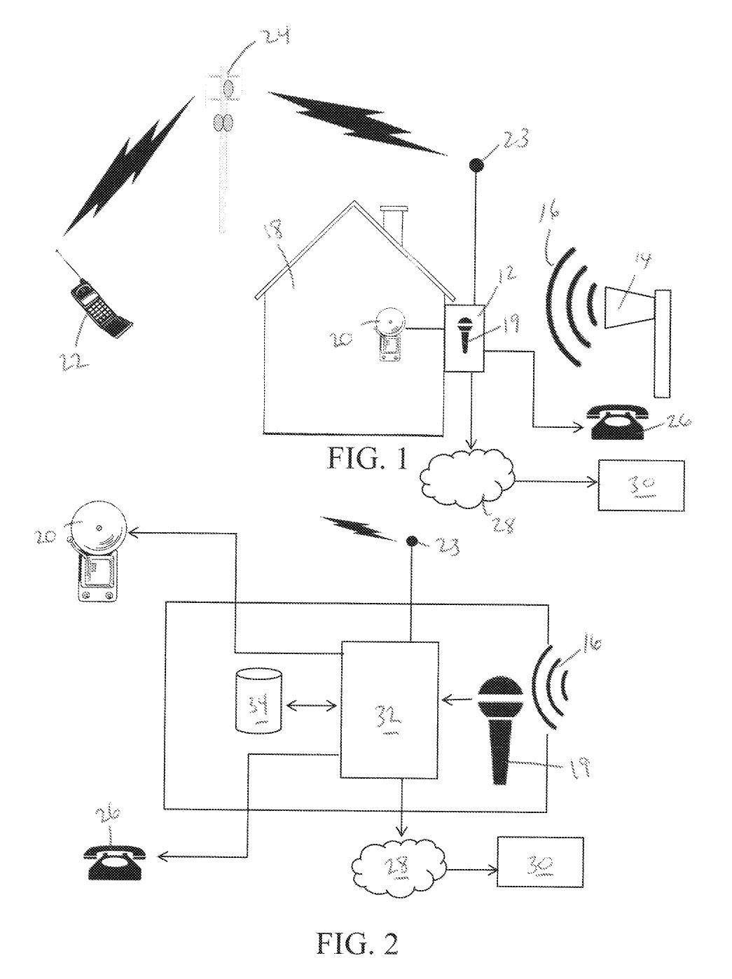

Referring now to the drawings, wherein like numerals refer to like parts, FIG. 1 illustrates a system 10 of the present invention. The system 10 generally includes an audio detection apparatus 12 that may be configured to detect an audible signal 16 generated by a siren 14. Generally, the siren 14 may be a civic alarm, such as a tornado alarm, a fire alarm, a hurricane alarm, a civil defense alarm, or any other type of alarm that sends an audible signal through the air for detection by the ears of an individual within the vicinity of the siren 14. For example, a siren 14 may be a tornado alarm that may be triggered upon the detection of a tornado or a tunnel cloud, communicating that individuals within the vicinity of the siren 14 should immediately take cover for protection.

Frequently, a siren 14 that may be used to alert individuals of imminent danger may not be heard by individuals in the vicinity, which may cause individuals to suffer damage or even death for failure to take cover during an emergency. For example, a siren 14 may send the audible signal 16 and individuals within a house 18 (or otherwise within a structure or vehicle) may not be able to hear the audible signal 16 due to walls, ambient noise, if asleep or for any other reason. For example, walls may muffle the audible signal 16 and prevent individuals within a house to hear the audible signal 16. Noise, such as music, television, computers, and other noise-making devices may make it difficult for an individual to hear the audible signal 16. Further, individuals that may suffer hearing loss or that may be asleep may not be able to audibly detect the audible signal 16.

Typically, the audible signal 16 is a siren blast, typically generated by pushing air through a disk or drum having perforations therein. Of course, any signal may be utilized as the audible signal 16 that may alert an individual of imminent danger.

The audio detection apparatus 12 may include a microphone 19 for receiving the audible signal 16 that may be generated by the siren 14. The audible signal 16, generally, is detected by the audio detection apparatus 12. Once detected, the audio detection apparatus 12 may trigger an alarm condition. The alarm condition may involve sending a signal to an internal alarm 20 that may be within the house 18 to alert occupants of the house that the audio detection apparatus 12 has detected the audible signal 16 generated by the siren 14. The alarm 20 may bean audible alarm, a visual alarm, or may generate any other sensory stimulus to alert an individual to the emergency situation where otherwise the individual would not be able to detect the audible signal 16 and take appropriate action.

Alternatively, the alarm condition may involve sending a signal to a user's cellular telephone 22 via a cellular antenna 23, a cellular tower 24 and a cellular network (not shown). Moreover, the alarm condition may involve sending a signal to a telephone 26 over a traditional PSTN network. Moreover, the alarm condition may involve sending a signal over the interim 28 to a receiver 30 to alert a user of the receiver 30 that the audio detection apparatus 12 has detected the audible signal 16 generated by the siren 14. Of course, any other method of alerting a user that the audio detection apparatus 12 has detected the audible signal 16 generated by the siren 14 may be utilized, as apparent to one or ordinary skill in the art upon reviewing the present disclosure.

FIG. 2 illustrates the audio detection apparatus 12 in further detail. Specifically, the audio detection apparatus may include the microphone 19. Upon detection of the audible signal via the microphone 19, the audio detection apparatus, via processor 32 may trigger the alarm condition, as noted above. Specifically, the triggering of the alarm condition within the audio detection apparatus 12 may occur when the audio detection apparatus 12 detects the audible signal 16, even if the audio detection apparatus 12 also receives other noises at the same time. Therefore, the audio detection apparatus 12 may be utilized to distinguish the audible signal 16 generated by the siren 14 from other noises that may be detected using the microphone 19. For example, the audio detection apparatus 12 may continually listen for audio signals via the microphone 19. Only upon detecting the audible signal 16 generated by the siren 14 will the audio detection apparatus 12 trigger the alarm condition, and alert users via the alarm. 20, the cellular telephone 22 using a cellular antenna 23, a telephone 26 over a traditional PSTN network, a receiver 30 via the internet 28, or with any other device, system and/or apparatus.

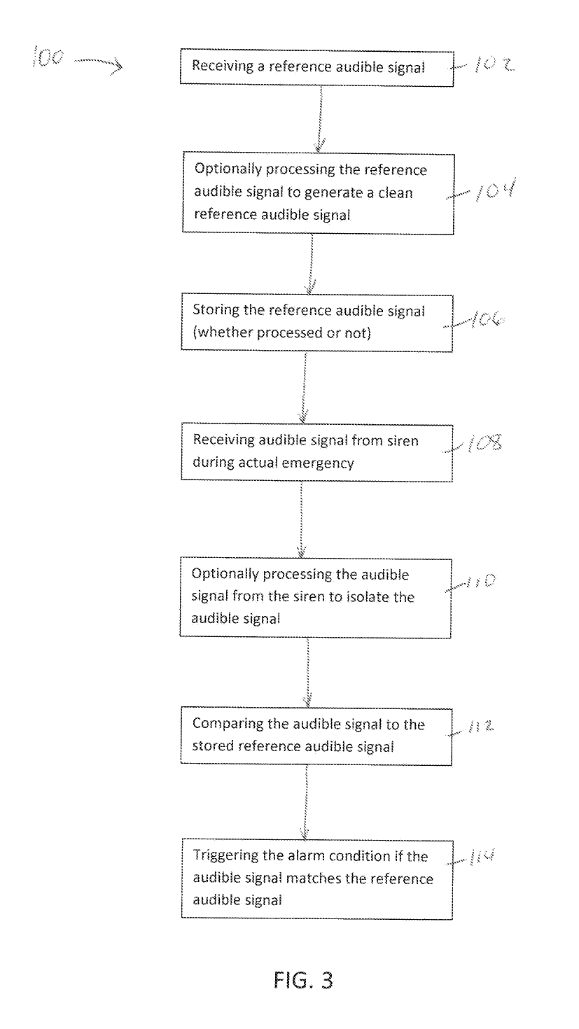

For example, a preferred method 100 of detecting the audible signal 16 and triggering the alarm condition is illustrated in FIG. 3. In a first step 102, a reference audible signal is received via the microphone 19. For example, the reference audible signal may be detected and recorded by the audio detection apparatus 12 when a user of the audio detection apparatus 12 knows that the reference audible signal is to be generated by the siren 14. Specifically, in many jurisdictions, the siren 14 may be scheduled to blare and produce the reference audible signal at a certain time on a certain day. For example, in the Midwest, it is typical for a tornado siren to be tested at 10:00 am on the first Tuesday of every month. Thus, the audio detection apparatus 12 may be programmed to listen for the reference audible signal at that time. Therefore, the reference audible signal may be recorded and stored in the database 34, and utilized as a reference during a comparison to detect the audible signal 16 generated by the siren 14 during an actual emergency, as detailed below. In addition, upon detecting the reference audible signal, the audio detection device may be programmed not to trigger the alarm condition, since it would merely be receiving the reference audible signal. For example, a user may program the audio detection apparatus 12 that the reference audible signal will be received by the audio detection apparatus 12 between 10:00 am and 10:05 am on the first Tuesday of every month. Upon detecting the reference audible signal, the reference audible signal is simply received, optionally processed and stored, as detailed below. But because the audio detection apparatus 12 is programmed to receive the reference audible signal as a reference, it will not trigger the alarm condition such as during an actual emergency.

The reference audible signal may require processing to ensure that a clean signal is utilized for the comparison via step 104. Thus, ambient noise that the audio detection apparatus 12 may receive at the same time as receiving the reference audible signal, such as traffic noise, storm noise, or any other like noise, may be reduced and/or eliminated from the reference audible signal. For example, as illustrated in FIG. 2, the processor 32 may process the reference audible signal to generate the clean signal and reduce or eliminate ambient noise, or otherwise reduce or eliminate noise that may make it difficult to compare to the audible signal 16 generated by the siren 14 during an actual emergency.

The reference audible signal may be processed using known processing algorithms, such as, for example, via Fourier Transform methodology, to better isolate the reference audible signal. Alternately, the audio detection apparatus 12 may detect a plurality of reference audible signals and utilize the plurality of reference audible signals to cancel ambient noise and isolate the reference audible signal via compounding of the reference audible signal. Specifically, if the audio detection apparatus receives a reference audible signal monthly at the time of the testing of the siren 14, then each of the reference audible signals may be compounded to eliminate ambient noise and isolate the reference audible signal. In addition or alternatively, the reference audible signal may include a plurality of repeating periods, and each period may be utilized to compound the reference audible signal and eliminate ambient noise.

The reference audible signal, whether optionally processed via step 104 or not, may be stored in a database 34 interconnected with the processor 32 (as illustrated in FIG. 2) via step 106. During times other than when the reference audible signal may be programmed to be detected by the audio detection apparatus 12 (such as during an actual emergency), the audio detection apparatus may receive the audible signal 16 from the siren 14 alerting people in the vicinity to take immediate cover due to the actual emergency, such as a tornado, via step 108. The audible signal 16 may be optionally processed via step 110 to isolate the audible signal generated by the siren 14 to provide a better comparison when comparing to the stored reference audible signal via step 112. If the audible signal (whether processed or not) matches the reference audible signal (whether processed or not), the alarm condition may be triggered via step 114. Individuals may then be alerted to the actual emergency via an audible alarm, a visual alarm, or other sensory stimulus. Moreover, individuals may be alerted via cellular telephone, either via an audio message or text, via telephone over a traditional PSTN, via the internet, or via any other method, as illustrated in FIGS. 1 and 2.

As with the reference audible signal, the audible signal received from the siren during an actual emergency may optionally be processed to isolate the audible signal, as generally disclosed above. For example, the audible signal may be processed via any technique that may be utilized to isolate the audible signal from ambient noise, or any other sounds that make it difficult to compare the audible signal to the reference audible signal. Moreover, the audio detection apparatus 12 may be made and/or calibrated to detect the audible signal at very low decibels and/or with a large amount of ambient noise. Thus, the audio detection apparatus 12 may be able to detect the audible signal better than an individual and, thus, the individual may be alerted to the emergency situation via the triggering of the alarm condition.

It should be noted that various changes and modifications to the presently preferred embodiments described herein will be apparent to those skilled in the art. Such changes and modifications may be made without departing from the spirit and scope of the present invention and without diminishing its attendant advantages.

1. An alarm detection apparatus as shown and described herein.

2. A method of using an alarm detection apparatus as shown and described herein.

3. A system for detecting an alarm, comprising an apparatus as shown and described herein.
